(19) United States
(12) Patent Application Publication
(10) Pub. No.: US 2013/0307519 A1
(43) Pub. Date: Nov. 21, 2013

(54) SWITCHING CIRCUIT AND ELECTRONIC DEVICE USING THE SAME

(71) Applicant: DONG-LIANG REN, Shenzhen (CN)

(72) Inventor: DONG-LIANG REN, Shenzhen (CN)

(21) Appl. No.: 13/677,332

(22) Filed: Nov. 15, 2012

(30) Foreign Application Priority Data
May 16, 2012 (CN) 201210151593.2

(51) Int. Cl. G05F 1/565

(52) U.S. Cl. CPC G05F 1/565
USPC 323/349

(57) ABSTRACT

An electronic device comprises a power supply, a load, a switching module, a voltage converting module, and a control module. The switching module establishes an electrical connection between the power supply and the voltage converting module when the electronic device is powered on. The voltage converting module is powered on through the switching module and outputs a working voltage. The control module is thus powered on. When the electronic device is powered off, the switching module is turned off, the voltage converting module stops outputting the working voltage, and the control module is disabled.

### BACKGROUND

1. Technical Field

The present disclosure relates to electronic devices, particularly relates to an electronic device with an internal battery.

2. Description of Related Art

An electronic device generally includes an internal battery and a control chip. The internal battery provides a working voltage to the control chip for powering on the control chip. However, when the electronic device is powered off, the internal battery still supplies the working voltage to the control chip through the voltage converting module, thus electrical energy supplied to the internal battery is wasted.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an electronic device in accordance with one embodiment.

FIG. 2 is a circuit diagram of the electronic device of FIG. 1 in accordance with one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at “least one.”

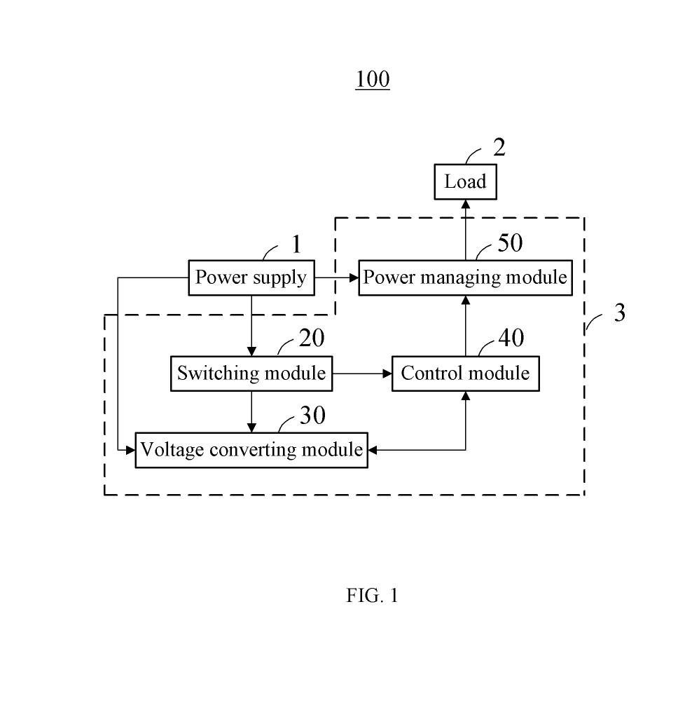

FIG. 1 shows an electronic device 100 of one embodiment of the present disclosure. The electronic device 100 includes a power supply 1, a load 2, and a switching circuit 3 connected between the power supply 1 and the load 2. The switching circuit 3 can establish an electrical connection between the power supply 1 and the load 2 or can cut off the electrical connection between the power supply 1 and the load 2. In the embodiment, the electronic device 100 can be a computer, or a TV, for example.

The power supply 1 provides a voltage to the switching circuit 3 when the electronic device 100 is powered on. In the embodiment, the power supply 1 is an internal battery.

The load 2 is capable of being powered by the power supply 1 to execute a function such as playing music or playing video, for example.

The switching circuit 3 is connected between the power supply 1 and the load 2. The switching circuit 3 establishes the electrical connection between the power supply 1 and the load 2 when the electronic device 100 is powered on and can cut off the electrical connection between the power supply 1 and the load 2 when the electronic device 100 is powered off. The switching circuit 3 includes a switching module 20, a voltage converting module 30, a control module 40, and a power managing module 50.

The switching module 20 is connected to the power supply 1, the voltage converting module 30, and the control module 40. The switching module 20 establishes an electrical connection between the power supply 1 and the voltage converting module 30 when the electronic device 100 is powered on, and cuts off the electrical connection between the power supply 1 and the voltage converting module 30 when the electronic device 100 is powered off. In another embodiment, the switching module 20 may turn off when the electronic device 100 is in a standby state.

The voltage converting module 30 is connected to the power supply 1, the switching module 20, and the control module 40. The voltage converting module is powered by the power supply 1 through the switching module 20 and outputs a working voltage to the control module 40.

The control module 40 is connected to the switching module 20, the voltage converting module 30, and the power managing module 50. The control module 40 detects whether the switching module 20 is turned off. The control module 40 provides a first control signal to the power managing module 50 and a feedback signal to the voltage converting module 30 when the switching module 20 is turned on. The control module 40 generates a second control signal when the switching module 20 is turned off and stops generating the feedback signal to the voltage converting module 30 after a predetermined period of time from the point in time when the control module 40 detects that the switching module 20 is turned off. In the embodiment, the predetermined period of time is a time period for powering off all loads; the first control signal and the feedback signal are logic high level signals, and the second control signal is a logic low level signal.

The voltage converting module 30 further continues to output the working voltage as long as the feedback signal is received when not receiving the voltage provided by the power supply 1, and stops outputting the working voltage when both the feedback signal from the control module 40 and the voltage of the power supply 1 are discontinued.

The power managing module 50 is connected between the power supply 1 and the load 2. The power managing module 50 establishes an electrical connection between the power supply 1 and the load 2 in response to the first control signal and cuts off the electrical connection between the power supply 1 and the load 2 within the predetermined period of time in response to the second control signal.

When the switching module 20 is turned off, the control module 40 continues to provides the feedback signal to the voltage converting module 30 and provides the second control signal to control the power managing module 50 to cut off the electrical connection between the power supply 1 and the load 2 within the predetermined period of time, and the voltage converting module 30 continues to output working voltage to the control module 40 based on the feedback signal. After the predetermined period of time, the control module 40 stops generating the feedback signal, the voltage converting module 30 stops generating the working voltage to the control module 40 and the control module 40 is disabled and stops further consumption of the electrical energy of the power supply 1, thus the consumption and waste of the power supply 1 is reduced.

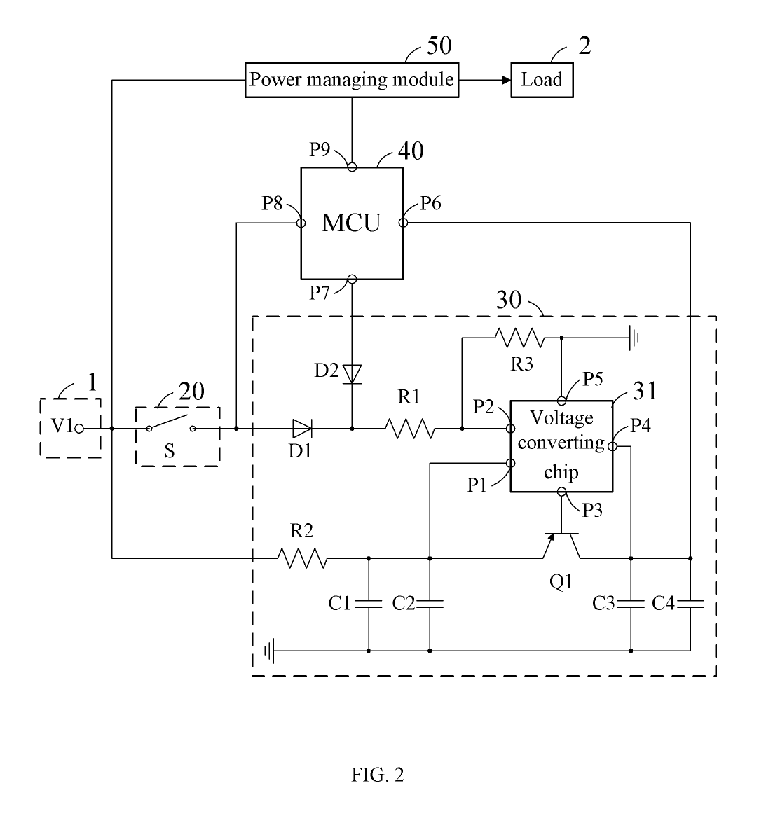

Referring to FIG. 2, the power supply 1 includes a power terminal V1. The switching module 20 includes a switch S. An end of the switch S is connected to the power terminal V1, and the other end of the switch S is connected to the voltage converting module 30 and the control module 40.

The voltage converting module 30 includes a switching diode D1, a feedback diode D2, a voltage converting chip 31, a transistor Q1, a first resistor R1, a second resistor R2, a third resistor R3, a first capacitor C1, a second capacitor C2, a third capacitor C3, and a fourth capacitor C4. An anode of the switching diode D1 is connected to the switch S, and a cathode of the switching diode D1 is electrically connected to the voltage converting chip 31 through the first resistor R1. An anode of the feedback diode D2 is electrically connected to the control module 40, and a cathode of the feedback diode D2 is electrically connected to the cathode of the switching diode D1. The voltage converting chip 31 includes a power pin P1, a first input pin P2, a first control pin P3, an output pin P4, and a ground pin P5. The power pin P1 is electrically connected to the power terminal V1 through the second resistor R3. The first input pin P2 is electrically connected to the cathode of the switching diode D1 through the first resistor R1. The first control pin P3 is electrically connected to a base of the transistor Q1. The output pin P4 is electrically connected to the control module 40. An end of the third resistor R3 is electrically connected to the first input pin P2, and the other end of the third resistor R3 is grounded. An emitter of the transistor Q1 is electrically connected to the power terminal V1 through the second resistor R2, and a collector of the transistor Q1 is electrically connected to the control module 40. The first capacitor C1 and the second capacitor C2 are electrically connected in parallel between the emitter of the transistor Q1 and ground. The third capacitor C3 and the fourth capacitor C4 are electrically connected in parallel between the collector of the transistor Q1 and ground. In the embodiment, the transistor is a pnp type bipolar junction transistor.

The control module 40 includes a second input pin P6, a feedback pin P7, a detecting pin P8, and a second control pin P9. The pin P6 is electrically connected to the output pin P4. The feedback pin P7 is electrically connected to the cathode of the feedback diode D2. The detecting pin P8 is electrically connected to the anode of the switching diode D1. The second control pin P9 is electrically connected to the power managing module 50. In the embodiment, the control module 40 is a micro control unit (MCU).

When the electronic device 100 is powered on, the switch S is turned on, both the power pin P1 and the emitter of the transistor Q1 receive the voltage generated by the power supply 1 through the second resistor R2. The voltage converting chip 31 is powered by the power terminal V1 through the switch S. The difference in voltage between the anode and cathode of the switching diode D1 is smaller than 0.3V, thus the switching diode D1 is turned on. The first input pin P2 receives the voltage of the power supply 1 through the diode D1 and the first resistor R1, and the first control pin P3 generates a pulsed voltage with a predetermined duty cycle, based on the voltage of the first input pin P2. When the pulsed voltage is at a high level, the difference between the base and the emitter of the transistor Q1 is almost 0V, and the transistor Q1 is turned off; when the pulsed voltage is at a low level, the difference in voltage between the base and the emitter of the transistor Q1 is smaller than 0V, the transistor Q1 is turned on and outputs the working voltage to the second input pin P6. The control module 40 is powered by the working voltage and outputs the feedback signal. The difference in voltage between the anode and the cathode of the feedback diode D2 is then greater than 0.3V, and the feedback diode D2 turns on. The detecting pin P8 is at a logic high level based on the voltage of the power supply 1 and the second control pin P9 generates a first control signal. The power managing module 50 establishes the electrical connection between the power supply 1 and the load 2 in response to the first control signal.

When the electronic device 100 is powered off, the switch S is turned off. The difference in voltage between the anode and the cathode of the switching diode D1 is smaller than 0.3V, thus the switching diode D1 turns off. The power pin P1 is at a logic low level, and the MCU 40 continues to being powered by the feedback signal generated by the feedback pin P7. The detecting pin P8 is at a logic low level, and the second control pin P9 provides the second control signal to the power managing module 50. The power managing module 50 cuts off the electrical connection between the power supply 1 and the load 2 within the predetermined period of time. After the predetermined period of time, the feedback pin P7 stops generating the feedback signal. The difference in voltage between the anode and the cathode of the feedback diode D2 is smaller than 0.3V, thus the feedback diode D2 turns off. The voltage converting chip 31 stops generating the working voltage, and the control module is disabled and stops consuming electrical energy from the power supply 1.

When the electronic device 100 is powered off, the voltage converting module 30 stops outputting the working voltage after the predetermined period of time from the point in time when the control module detects that the switching module is turned off, and the control module is disabled and stops consuming electrical energy. Therefore, the consumption of electrical energy of the internal battery is reduced.

It is to be understood, however, that even though information and advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device, comprising:
a power supply;
a load;
a voltage converting module connected to the power supply;
a switching module capable of cutting off an electrical connection between the power supply and the voltage converting module; and
a control module connected to the switching module and the power managing module;
wherein when the switching module is turned on, the voltage converting module is powered by the power supply through the switching module and outputs a working voltage through the switching module and the control module is powered by the working voltage;
when the switching module is turned off, the voltage converting module stops outputting the working voltage and the control module is disabled.

2. The electronic device of claim 1, wherein the control module further provides a feedback signal to the voltage converting module when being powered and detects whether the switching module is turned off; when switching module is turned off, the voltage converting module continues to output the working voltage to the control module based on the feedback signal; the control module stop generating the feedback signal after a predetermined period of time from the point in time when the control module detects that the switching module is turned off, the voltage converting module stops outputting the working voltage without the feedback signal and the voltage provided by the power supply.

3. The electronic device of claim 2, wherein the electronic device further comprises a power managing module connected between the power supply and the load; the control module further controls the power managing module to establish an electrical connection between the power supply and the load when the switching module is turned on.

4. The electronic device of claim 2, wherein when the switching module is turned off, the control module further controls the power managing module to cut off the electrical connection between the power supply and the load within the predetermined period of time.

5. The electronic device of claim 1, wherein the voltage converting module comprises a voltage converting chip for generating the working voltage and a transistor; the voltage converting chip includes a power pin, a first input pin for receiving the voltage from the power supply through the switching module or the feedback signal, a first control pin for controlling the transistor, and an output pin for outputting the working voltage; the power pin is electrically connected to the power supply; a base of the transistor is electrically connected to the control pin, an emitter of the transistor is electrically connected to the power supply, a collector of the transistor is electrically connected to the output pin; when the first input pin receives the voltage from the power supply through the switching module or the feedback signal, the first control pin generates a pulse voltage, the transistor turns on when the pulse voltage is at a low level and turns off when the pulse voltage is at a high level.

6. The electronic device of claim 5, wherein the voltage converting module further comprises a switching diode and a feedback diode, the voltage converting module further comprises a first input pin; an anode of the switching diode is electrically connected to the switching module, a cathode of the switching diode is electrically connected to the first input pin; an anode of the feedback diode is electrically connected to the control module, a cathode of the feedback diode is electrically connected to the input pin.

7. The electronic device of claim 5, wherein the transistor is a pnp type bipolar junction transistor.

8. The electronic device of claim 6, wherein the control module comprise a micro controller unit (MCU), the MCU comprise a second input pin, a detecting pin, a second control pin, and a feedback pin; the second input pin is electrically connected to the output pin, the detecting pin is electrically connected to the switching module, the second control pin is electrically connected to the power managing module, the feedback pin is electrically connected to the anode of the feedback diode.

9. A switching circuit connected to a power supply; the switching circuit comprising:
a voltage converting module connected to the power supply;
a switching module capable of cutting off an electrical connection between the power supply and the voltage converting module; and
a control module connected to the switching module and the voltage converting module;
wherein when the switching module is turned on, the voltage converting module is powered by the power supply through the switching module to generate a working voltage and the control module is powered by the working voltage; when the switching module is turned off, the voltage converting module stops outputting the working voltage and the control module is disabled.

10. The switching circuit of claim 9, wherein the control module further provides a feedback signal to the voltage converting module when being powered and detects whether the switching module is turned off; when switching module is turned off, the voltage converting module continues to output the working voltage to the control module based on the feedback signal; the control module stop generating the feedback signal after a predetermined period of time from the point in time when the control module detects that the switching module is turned off, the voltage converting module stops outputting the working voltage without the feedback signal and the voltage provided by the power supply.

11. The switching circuit of claim 10, further comprising a power managing module, wherein the switching module further connected to a load; the power managing module is connected between the power supply and the load; the control module further controls the power managing module to establish an electrical connection between the power supply and the load when the switching module is turned on.

12. The switching circuit of claim 11, wherein when the switching module is turned off, the control module further controls the power managing module to cut off the electrical connection between the power supply and the load within the predetermined period of time.

13. The switching circuit of claim 9, wherein the voltage converting module comprises a voltage converting chip for generating the working voltage and a transistor; the voltage converting chip includes a power pin, a first input pin for receiving the voltage from the power supply through the switching module or the feedback signal, a first control pin for controlling the transistor, and an output pin for outputting the working voltage; the power pin is electrically connected to the power supply; a base of the transistor is electrically connected to the control pin, an emitter of the transistor is electrically connected to the power supply, a collector of the transistor is electrically connected to the output pin; when the first input pin receives the voltage from the power supply through the switching module or the feedback signal, the first control pin generates a pulse voltage, the transistor turns on when the pulse voltage is at a low level and turns off when the pulse voltage is at a high level.

14. The switching circuit of claim 13, wherein the voltage converting module further comprises a switching diode and a feedback diode, the voltage converting module further comprises a first input pin; an anode of the switching diode is electrically connected to the switching module, a cathode of the switching diode is electrically connected to the first input pin; an anode of the feedback diode is electrically connected to the control module, a cathode of the feedback diode is connected to the input pin.

15. The switching circuit of claim 13, wherein the transistor is a pnp type bipolar junction transistor.

16. The switching circuit of claim 14, wherein the control module comprises a micro controller unit (MCU), the MCU comprise a second input pin, a detecting pin, a second control pin, and a feedback pin; the second input pin is connected to the output pin, the detecting pin is connected to the switching module, the second control pin is connected to the power managing module, the feedback pin is connected to the anode of the feedback diode.
